(19) United States
(12) Patent Application Publication
(10) Pub. No.: US 2026/0156614 A1
(43) Pub. Date: Jun. 4, 2026

(54) ON-DEMAND SIGNAL FOR PAGING

(71) Applicant: Samsung Electronics Co., Ltd., Suwon-si (KR)

(72) Inventor: Hongbo Si, Allen, TX (US)

(21) Appl. No.: 19/382,245

(22) Filed: Nov. 6, 2025

Related U.S. Application Data
(60) Provisional application No. 63/727,859, filed on Dec. 4, 2024.
(60) Provisional application No. 63/863,628, filed on Aug. 14, 2025.

(51) Int. Cl. H04W 68/02; H04W 24/10; H04W 56/00; H04W 74/0816

(52) U.S. Cl. CPC H04W 68/02; H04W 24/10; H04W 56/0015; H04W 74/0816

(57) ABSTRACT

Methods and apparatuses for on-demand signal for paging. A method includes receiving a set of higher layer parameters, determining, based on the set of higher layer parameters, a first set of configurations for paging and a second set of configurations for an on-demand signal, identifying a first set of time domain occasions for paging information based on the first set of configurations, and identifying a second set of time domain occasions for the on-demand signal based on the second set of configurations. The method further includes determining an association between the first set of time domain occasions and the second set of time domain occasions, receiving the on-demand signal based on the second set of time domain occasions, and receiving the paging information based on the first set of time domain occasions and the association.

### CROSS-REFERENCE TO RELATED APPLICATIONS AND CLAIM OF PRIORITY

The present application claims priority to: U.S. Provisional Patent Application No. 63/727,859, filed on Dec. 4, 2024; and U.S. Provisional Patent Application No. 63/863,628, filed on Aug. 14, 2025. The contents of the above-identified patent documents are incorporated herein by reference.

### TECHNICAL FIELD

The present disclosure relates generally to wireless communication systems and, more specifically, the present disclosure relates to an on-demand signal for paging in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to an on-demand signal for paging in a wireless communication system.

In one embodiment, a user equipment (UE) in a wireless communication system is provided. The UE includes a transceiver configured to receive a set of higher layer parameters and a processor operably coupled to the transceiver. The processor is configured to determine, based on the set of higher layer parameters, a first set of configurations for paging and a second set of configurations for an on-demand signal, identify a first set of time domain occasions for paging information based on the first set of configurations, identify a second set of time domain occasions for the on-demand signal based on the second set of configurations, and determine an association between the first set of time domain occasions and the second set of time domain occasions. The transceiver is further configured to receive the on-demand signal based on the second set of time domain occasions and receive the paging information based on the first set of time domain occasions and the association.

In another embodiment, a base station (BS) in a wireless communication system is provided. The BS includes a processor configured to determine a first set of configurations for paging and a second set of configurations for an on-demand signal and determine an association between a first set of time domain occasions and a second set of time domain occasions. The first set of configurations include configurations for the first set of time domain occasions for paging information. The second set of configurations include configurations for the second set of time domain occasions for the on-demand signal. The BS further includes a transceiver operably coupled to the processor. The transceiver is configured to transmit a set of higher layer parameters including the first and second set of configurations, transmit the on-demand signal based on the second set of time domain occasions, and transmit the paging information based on the first set of time domain occasions and the association.

In yet another embodiment, a method of a UE in a wireless communication system is provided. The method includes receiving a set of higher layer parameters, determining, based on the set of higher layer parameters, a first set of configurations for paging and a second set of configurations for an on-demand signal, identifying a first set of time domain occasions for paging information based on the first set of configurations, and identifying a second set of time domain occasions for the on-demand signal based on the second set of configurations. The method further includes determining an association between the first set of time domain occasions and the second set of time domain occasions, receiving the on-demand signal based on the second set of time domain occasions, and receiving the paging information based on the first set of time domain occasions and the association.

Other technical features may be readily apparent to one skilled in the art from the figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to this disclosure;

FIG. 6 illustrates examples of on-demand signals in paging procedures according to embodiments of the present disclosure; and

FIG. 7 illustrates a method performed by a UE in a wireless communication system according to embodiments of the present disclosure.

### DETAILED DESCRIPTION

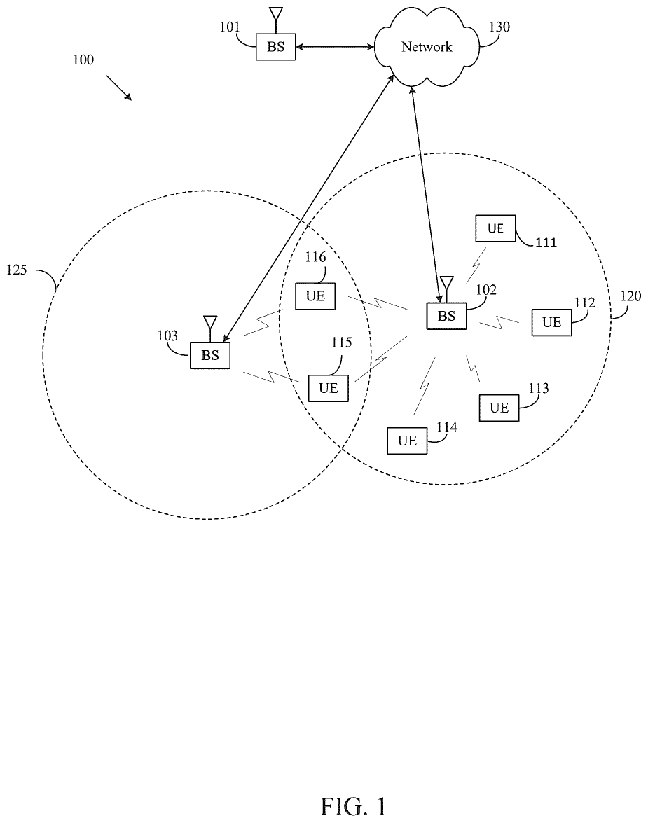

FIGS. 1-7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v18.1.0, “NR; Physical channels and modulation”; 3GPP TS 38.212 v18.1.0, “NR; Multiplexing and channel coding”; 3GPP TS 38.213 v18.1.0, “NR; Physical layer procedures for control”; 3GPP TS 38.214 v18.1.0, “NR; Physical layer procedures for data”; and 3GPP TS 38.331 v18.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for an on-demand signal for paging in a wireless communication system. In certain embodiments, and one or more of the gNBs 101-103 includes circuitry, programing, or a combination thereof, for supporting an operation for configurations for an on-demand signal for paging in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

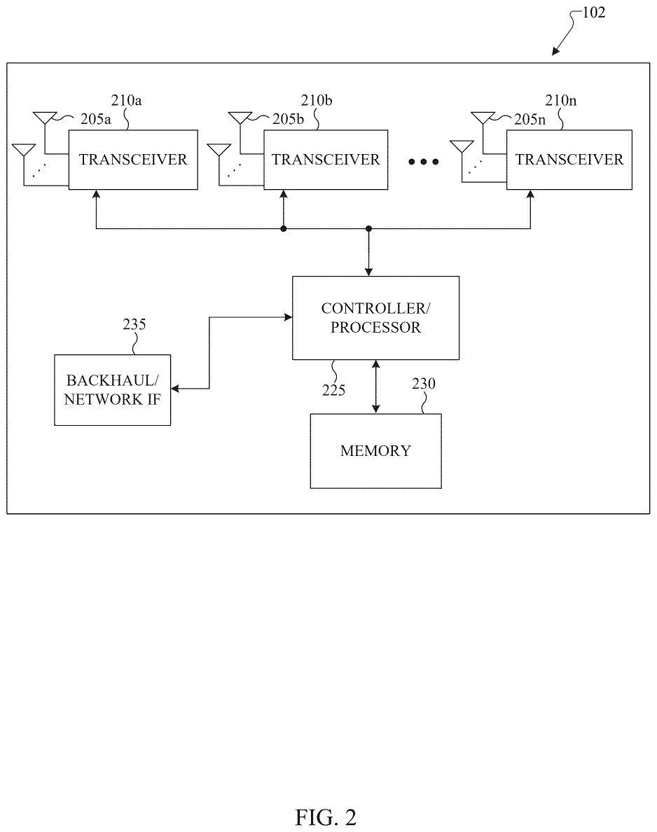

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting an on-demand signal for paging in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

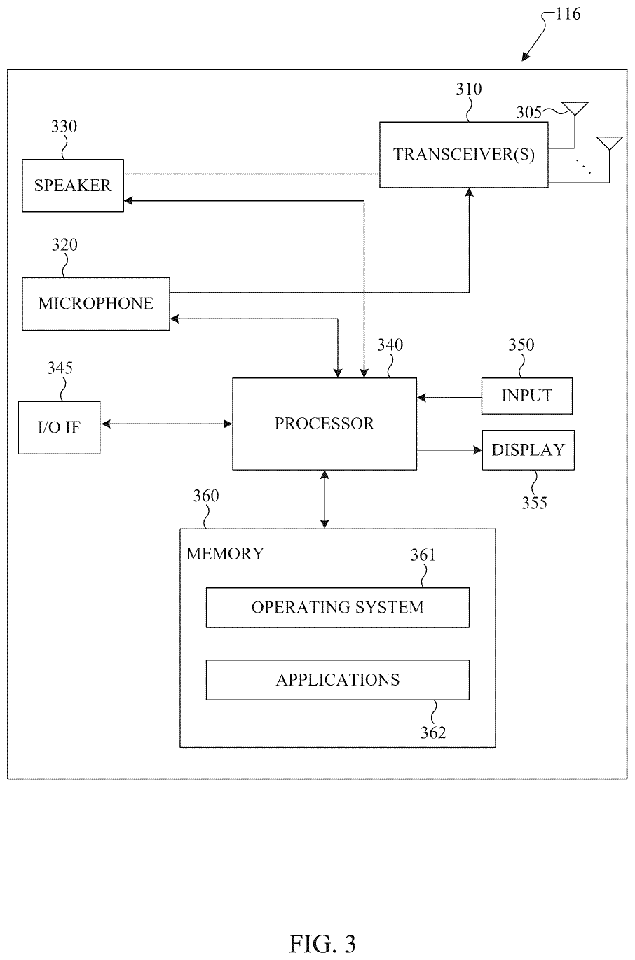

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an on-demand signal for paging in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

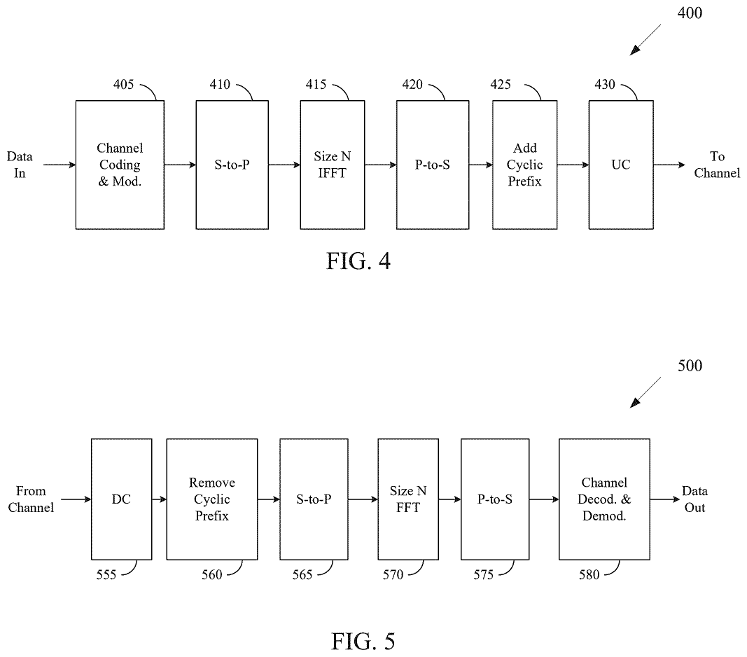

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In various embodiments, the receive path 500 can be implemented in a first UE and the transmit path 400 can be implemented in a second UE. In some embodiments, the receive path 500 is configured to an on-demand signal for paging in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

Various embodiments of the present disclosure recognize that in NR, a cell can be configured with synchronization signals and/or physical broadcast channel (SS/PBCH) block (SSB) transmissions, wherein the transmissions are in a periodic manner and the periodicity of the SSB is configured by a BS. For initial access procedure, e.g., the UE is not provided with the configuration of the periodicity of the SSB yet, the UE can assume the periodicity for the SSB transmission is 20 ms. After the initial access procedure, the UE can acquire the configuration of the periodicity for the SSB transmission, and assume the SSB transmission following the configured periodicity. The UE may not expect the periodicity for the SSB transmission varies if no reconfiguration of the parameter is provided to the UE.

The periodic transmission of SSB using a configured periodicity may result in high energy consumption from the network perspective. For example, when the data traffic is high or mobility of the UE is fast, the network may need a short periodicity for the SSB transmission such that the UE may maintain good synchronization and perform good measurement in order to receive high amount of data and to adapt with the mobility. However, when the data traffic is low or mobility of the UE is slow, the network may not need to configure a short periodicity for the SSB transmission, and it can save energy by configuring a long periodicity for the SSB transmission. To achieve the purpose of unequal interval between SSB transmissions, on-demand signal (e.g., on-demand SSB) can be supported, independently or jointly with periodic SSB transmissions on the same cell.

For example, the on-demand signal (ODS) in the present disclosure can also be referred to as an on-demand synchronization signal (OD-SS) or an on-demand reference signal (OD-RS) (e.g., such as tracking reference signal (TRS) or channel state information reference signal (CSI-RS)) or an on-demand SS/PBCH block (OD-SSB), subject to the component signals included in the on-demand signal.

In one example, the on-demand signal (e.g., on-demand SSB) can be applicable for RRC CONNECTED mode.

In one example, the on-demand signal (e.g., on-demand SSB) can be applicable for RRC IDLE mode.

In one example, the on-demand signal (e.g., on-demand SSB) can be applicable for RRC_INACTIVE mode.

In one example, the on-demand signal (e.g., on-demand SSB) can be applicable for a primary cell (PCell).

In one example, the on-demand signal (e.g., on-demand SSB) can be applicable for a secondary cell (SCell).

In one example, the on-demand signal (e.g., on-demand SSB) can be applicable for a primary secondary cell (PSCell).

In one example, the on-demand signal (e.g., on-demand SSB) can be applicable for SSB as cell-defining SSB (e.g., with associated system information block #1 (SIB1) transmission).

In one example, the on-demand signal (e.g., on-demand SSB) can be applicable for SSB as non-cell-defining SSB (e.g., without associated SIB1 transmission).

In one example, the on-demand signal (e.g., on-demand SSB) can be applicable for SSB located at a frequency layer given by a synchronization raster entry (e.g., corresponding to a global synchronization channel number (GSCN)).

In one example, the on-demand signal (e.g., on-demand SSB) can be applicable for SSB located at a frequency layer not given by a synchronization raster entry (e.g., not corresponding to a GSCN).

In one example, the on-demand signal (e.g., on-demand SSB) can include multiple components, wherein a first component (e.g., on-demand synchronization signals) within the multiple components can be according to a first example of the present disclosure, and a second component (e.g., on-demand PBCH) within the multiple components can be according to a second example of the present disclosure. The first component can carry information on the configuration of the second component, therein the configuration can be according to examples of the present disclosure. For one further implementation, a UE can receive the first component to acquire the configuration of the second component, and then receive the second component based on the acquired configuration.

Accordingly, embodiments of the present disclosure provide methods and apparatuses for an on-demand SSB to be utilized in a paging procedure. Aspects of the present disclosure include (i) a procedure for on-demand SSB in paging; (ii) a configuration for on-demand SSB; (iii) a design of a DL trigger; (iv) a design of a UL request; (v) a relationship between on-demand SSB and periodic SSB in the same cell; and (vi) an example UE procedure.

In one embodiment, transmissions of an on-demand signal (e.g., on-demand SSB) can be non-periodic and/or in an on-demand manner, e.g., at least to facilitate a paging procedure on a cell.

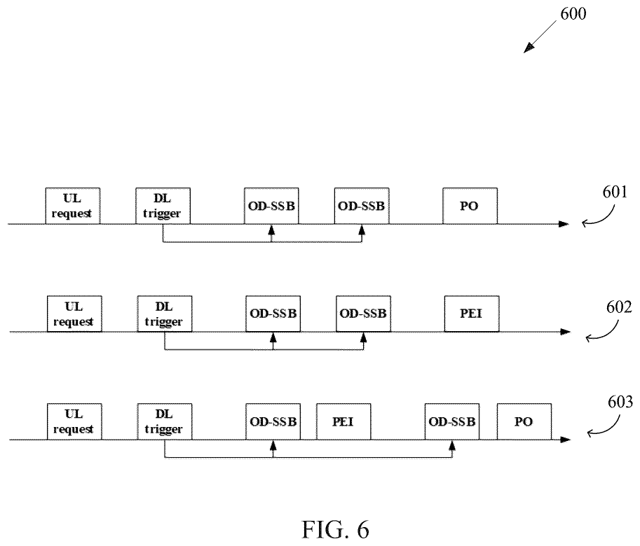

FIG. 6 illustrates examples 601-603 of on-demand signals in paging procedures according to embodiments of the present disclosure. The examples 601-603 are for illustration only and other embodiments can be used without departing from the scope of the present disclosure.

In one example, as shown in 601 of FIG. 6, on-demand signal(s) (e.g., on-demand SSB(s)) can be transmitted before a paging occasion (PO).
In one example, the transmission of the on-demand signal(s) (e.g., on-demand SSB(s)) can be indicated to a UE by a DL trigger.
In one example, the DL trigger can be absent in some example of the present disclosure, e.g., the UE can assume the transmission of the on-demand signal(s) can be associated with the paging.
In another example, the transmission of the on-demand signal(s) (e.g., on-demand SSB(s)) can be requested by the UE, e.g., by a UL request.
In yet another example, the UL request can be absent in some examples of the present disclosure.
In yet another example, the PO can be a first PO in a paging frame, or a first PO in a paging cycle.

In one example, as shown in 602 of FIG. 6, on-demand signal(s) (e.g., on-demand SSB(s)) can be transmitted before a paging early indication (PEI), which is also referred to as wake-up indication for paging procedure (e.g., the PEI or the wake-up indication can be carried by a signal or a physical downlink control channel (PDCCH)).
In one example, the transmission of the on-demand signal(s) (e.g., on-demand SSB(s)) can be indicated to a UE by a DL trigger.
In one example, the DL trigger can be absent in some examples of the present disclosure, e.g., the UE can assume the transmission of the on-demand signal(s) can be associated with the PEI.
In one example, the transmission of the on-demand signal(s) (e.g., on-demand SSB(s)) can be requested by the UE, e.g., by a UL request.
In another example, the UL request can be absent in some example of the present disclosure.
In yet another example, the PEI can be a first PEI in a burst of PEI transmissions.

In one example, as shown in 603 of FIG. 6, on-demand signal(s) (e.g., on-demand SSB(s)) can be transmitted before a paging early indication (PEI) and before PO(s) associated with the PEI.
In one example, the transmission of the on-demand signal(s) (e.g., on-demand SSB(s)) can be indicated to a UE by a DL trigger.
In one example, the DL trigger can be absent in some example of the present disclosure, e.g., the UE can assume the transmission of the on-demand signal(s) can be associated with the PEI and/or the paging.
In another example, the transmission of the on-demand signal(s) (e.g., on-demand SSB(s)) can be requested by the UE, e.g., by a UL request.
In another example, the UL request can be absent in some example of the present disclosure.
In another example, the PEI can be a first PEI in a burst of PEI transmissions.
In yet another example, the PO can be a first PO in a paging frame, or a first PO in a paging cycle.

In one example, the on-demand signal (e.g., on-demand SSB) can be used as a wake-up-indication for monitoring the associated PO(s) and/or PEI. For instance, if a UE receives the on-demand signal (e.g., at least one on-demand signal or all of the on-demand signals when multiple on-demand signals are configured), the UE can determine to monitor the associated PO(s) and/or PEI.

In another example, the on-demand signal (e.g., on-demand SSB) can be at least used for downlink synchronization purpose.
In one example, the on-demand signal can be used for Layer-1 measurement (e.g., CSI measurement).
In another example, the on-demand signal can be used for Layer-3 measurement (e.g., radio resource management (RRM) measurement).
In another example, the on-demand signal can be used for radio link monitoring.
In another example, the on-demand signal can be used for radio link recovery.
In yet another example, the on-demand signal can be used for path loss calculation for uplink power control (e.g., for PRACH power control).

In another example, there can be an association (or mapping) between (burst(s) of) on-demand signal(s) and one or multiple paging occasions.
In one example, the association (or mapping) can be one-to-one, e.g., one burst of on-demand signal(s) is associated with one paging occasion or one on-demand signal(s) is associated with one paging occasion.
In one example, the association (or mapping) can be one-to-multiple, e.g., one burst of on-demand signal(s) is associated with multiple paging occasions or one on-demand signal(s) is associated with multiple paging occasions, wherein the multiple paging occasions can be paging occasions in a paging frame, or paging occasions in a paging cycle.
In another example, the association (or mapping) can be multiple-to-one, e.g., multiple bursts of on-demand signal(s) is associated with one paging occasion, or multiple on-demand signal(s) is associated with one paging occasion.
In yet another example, there can be a configuration of at least two of above examples, e.g., configuration on the number of paging occasions associated with one (burst of) on-demand signal, and/or configuration on the number of (bursts of) on-demand signal associated with one paging occasion.

In one embodiment, at least one of the following example parameters can be known to the UE for the on-demand signal (e.g., on-demand SSB).

In one example, a frequency location of the on-demand signal (e.g., on-demand SSB) (e.g., the location of the center subcarrier of the on-demand SSB, or the location of the lowest resource block (RB) or subcarrier of the on-demand signal) can be known to the UE.
In one example, the frequency location of the on-demand signal (e.g., on-demand SSB) can be configured by the BS, e.g., included in system information block (e.g., SIB1 or SIBx where x>1) on the same cell, or carried by the periodic SSB on the same cell, or included in system information block (e.g., SIB1 or SIBx where x>1) in another cell. For one further implementation, this example can be applicable when there does not exist periodic SSB in the same cell.
In one example, the frequency location of the on-demand signal (e.g., on-demand SSB) can be indicated by the DL trigger. For one further implementation, this example can be applicable when there does not exist periodic SSB in the same cell.
In one example, the frequency location of the on-demand signal (e.g., on-demand SSB) can be included in the UL request. For one further implementation, this example can be applicable when there does not exist periodic SSB in the same cell.
In one example, the frequency location of the on-demand signal (e.g., on-demand SSB) can be determined based on the periodic SSB in the same cell, e.g., same frequency location as the periodic SSB in the same cell, or with a fixed frequency offset as the periodic SSB in the same cell. For one further implementation, this example can be applicable when there exists periodic SSB in the same cell. For another further implementation, this example can be applicable when no explicit configuration or indication (e.g., as in the examples of the present disclosure) of the frequency location is provided to the UE.

In one example, a physical cell identity (ID) associated with the on-demand signal (e.g., on-demand SSB) can be known to the UE, such as the physical cell ID utilized for a generation of sequence mapped for the on-demand signal.
In one example, the physical cell ID of the on-demand signal (e.g., on-demand SSB) can be configured by the BS, e.g., included in system information block (e.g., SIB1 or SIBx where x>1) on the same cell, or carried by the periodic SSB on the same cell, or included in system information block (e.g., SIB1 or SIBx where x>1) in another cell. For one further implementation, this example can be applicable when there does not exist periodic SSB in the same cell.
In one example, the physical cell ID of the on-demand signal (e.g., on-demand SSB) can be indicated by the DL trigger. For one further implementation, this example can be applicable when there does not exist periodic SSB in the same cell.
In one example, the physical cell ID of the on-demand signal (e.g., on-demand SSB) can be included in the UL request. For one further implementation, this example can be applicable when there does not exist periodic SSB in the same cell.
In one example, the physical cell ID of the on-demand signal (e.g., on-demand SSB) can be determined based on the periodic SSB in the same cell, e.g., same physical cell ID as the periodic SSB in the same cell, or with a predetermined association relationship with the periodic SSB in the same cell. For one further implementation, this example can be applicable when there exists periodic SSB in the same cell. For another further implementation, this example can be applicable when no explicit configuration or indication (e.g., as in the examples of the present disclosure) of the physical cell ID is provided to the UE.

In one example, a subcarrier spacing of the on-demand signal (e.g., on-demand SSB) can be known to the UE.
In one example, the subcarrier spacing of the on-demand signal (e.g., on-demand SSB) can be configured by the BS, e.g., included in system information block (e.g., SIB1 or SIBx where x>1) on the same cell, or carried by the periodic SSB on the same cell, or included in system information block (e.g., SIB1 or SIBx where x>1) in another cell. For one further implementation, this example can be applicable when there does not exist periodic SSB in the same cell.
In one example, the subcarrier spacing of the on-demand signal (e.g., on-demand SSB) can be indicated by the DL trigger. For one further implementation, this example can be applicable when there does not exist periodic SSB in the same cell.
In one example, the subcarrier spacing of the on-demand signal (e.g., on-demand SSB) can be included in the UL request. For one further implementation, this example can be applicable when there does not exist periodic SSB in the same cell.
In one example, the subcarrier spacing of the on-demand signal (e.g., on-demand SSB) can be determined based on the periodic SSB in the same cell and/or the configuration of carrier or cell including the on-demand signal, e.g., same subcarrier spacing as the periodic SSB in the same cell, or same subcarrier spacing as the carrier or cell including the on-demand signal. For one further implementation, this example can be applicable when there exists periodic SSB in the same cell. For another further implementation, this example can be applicable when no explicit configuration or indication (e.g., as in the examples of the present disclosure) of the subcarrier spacing is provided to the UE.

In one example, a transmission power or an offset of the transmission power of the on-demand signal (e.g., on-demand SSB) can be known to the UE.
In one example, the transmission power or the offset of the transmission power of the on-demand signal (e.g., on-demand SSB) can be configured by the BS, e.g., included in system information block (e.g., SIB1 or SIBx where x>1) on the same cell, or carried by the periodic SSB on the same cell, or included in system information block (e.g., SIB1 or SIBx where x>1) in another cell. For one further implementation, this example can be applicable when there does not exist periodic SSB in the same cell.
In one example, the transmission power or the offset of the transmission power of the on-demand signal (e.g., on-demand SSB) can be indicated by the DL trigger. For one further implementation, this example can be applicable when there does not exist periodic SSB in the same cell.
In one example, the transmission power or the offset of the transmission power of the on-demand signal (e.g., on-demand SSB) can be included in the UL request. For one further implementation, this example can be applicable when there does not exist periodic SSB in the same cell.
In one example, the transmission power or the offset of the transmission power of the on-demand signal (e.g., on-demand SSB) can be determined based on the periodic SSB in the same cell, e.g., same transmission power as the periodic SSB in the same cell, or with a predetermined association relationship with the periodic SSB in the same cell. For one further implementation, this example can be applicable when there exists periodic SSB in the same cell. For another further implementation, this example can be applicable when no explicit configuration or indication (e.g., as in the examples of the present disclosure) of the transmission power or the offset of the transmission power is provided to the UE.
In one example, when there exists periodic SSB in the same cell, the transmission power of the on-demand signal (e.g., on-demand SSB) can be smaller than or no larger than the transmission power of the periodic SSB, or the offset of the transmission power is zero or a positive value.

In one example, at least one periodicity (or a time interval between two consecutive on-demand signal (e.g., on-demand SSB) bursts) of the on-demand signal (e.g., on-demand SSB) can be known to the UE. For instance, the periodicity (or interval) can be in a unit of half frame or frame.
In one example, the periodicity (or interval) of the on-demand signal (e.g., on-demand SSB) can be configured by the BS, e.g., included in system information block (e.g., SIB1 or SIBx where x>1) on the same cell, or carried by the periodic SSB on the same cell, or included in system information block (e.g., SIB1 or SIBx where x>1) in another cell. For one further implementation, this example can be applicable when there does not exist periodic SSB in the same cell.
In one example, the periodicity (or interval) of the on-demand signal (e.g., on-demand SSB) can be indicated by the DL trigger. For one further implementation, this example can be applicable when there does not exist periodic SSB in the same cell.
In one example, the periodicity (or interval) of the on-demand signal (e.g., on-demand SSB) can be included in the UL request. For one further implementation, this example can be applicable when there does not exist periodic SSB in the same cell.
In one example, the periodicity (or interval) of the on-demand signal (e.g., on-demand SSB) can be determined based on the periodic SSB in the same cell, e.g., same periodicity (or interval) as the periodic SSB in the same cell, or with a predetermined association relationship with the periodic SSB in the same cell. For one further implementation, this example can be applicable when there exists periodic SSB in the same cell. For another further implementation, this example can be applicable when no explicit configuration or indication (e.g., as in the examples of the present disclosure) of the periodicity (or interval) is provided to the UE.
In one example, the periodicity (or interval) of the on-demand signal (e.g., on-demand SSB) can be pre-determined in the specification of system operation, such as a half frame or a frame.
In one example, when there exists periodic SSB in the same cell, the periodicity (or interval) of the on-demand signal (e.g., on-demand SSB) can be smaller than or no larger than the periodicity of the periodic SSB.
In one example, for the procedure of on-demand signal (e.g., on-demand SSB) used for both before PEI and before PO (e.g., as shown in 403 of FIG. 4), the periodicity (or interval) for on-demand SSB(s) before PEI and before PO can be different, e.g., a first periodicity (or interval) for on-demand SSB(s) before PEI is configured/indicated/determined based on a first example of the present disclosure, and a second periodicity (or interval) for on-demand SSB(s) before PO is configured/indicated/determined based on a second example of the present disclosure.

In one example, at least a number of the on-demand signal (e.g., on-demand SSB) bursts (or a duration of time window for on-demand signal (e.g., on-demand SSB) transmissions) can be known to the UE.
In one example, the number of the on-demand signal (e.g., on-demand SSB) bursts (or a duration of time window for on-demand signal (e.g., on-demand SSB) transmissions) can be configured by the BS, e.g., included in system information block (e.g., SIB1 or SIBx where x>1) on the same cell, or carried by the periodic SSB on the same cell, or included in system information block (e.g., SIB1 or SIBx where x>1) in another cell.
In one example, the number of the on-demand signal (e.g., on-demand SSB) bursts (or a duration of time window for on-demand signal (e.g., on-demand SSB) transmissions) can be indicated by the DL trigger.
In one example, the number of the on-demand signal (e.g., on-demand SSB) bursts (or a duration of time window for on-demand signal (e.g., on-demand SSB) transmissions) can be included in the UL request.
In one example, the number of the on-demand signal (e.g., on-demand SSB) bursts (or a duration of time window for on-demand signal (e.g., on-demand SSB) transmissions) can be determined based on implicit condition, e.g., until an end of the paging cycle, or until an end of the paging frame, or until a location of PO/PEI. For one further implementation, this example can be applicable when no explicit configuration or indication (e.g., as in the examples of the present disclosure) of the number of the on-demand signal (e.g., on-demand SSB) bursts (or a duration of time window for on-demand signal (e.g., on-demand SSB) transmissions) is provided to the UE.
In one example, the number of the on-demand signal (e.g., on-demand SSB) bursts (or a duration of time window for on-demand signal (e.g., on-demand SSB) transmissions) can be pre-determined in the specification of system operation, such as 1 or 2 or 3.
In one example, for the procedure of on-demand signal (e.g., on-demand SSB) used for both before PEI and before PO (e.g., as shown in 403 of FIG. 4), the number of the on-demand signal (e.g., on-demand SSB) bursts (or a duration of time window for on-demand signal (e.g., on-demand SSB) transmissions) before PEI and before PO can be different, e.g., a first number of the on-demand signal (e.g., on-demand SSB) bursts (or a duration of time window for on-demand signal on-demand (e.g., SSB) transmissions) before PEI is configured/indicated/determined based on a first example of the present disclosure, and a second number of the on-demand signal (e.g., on-demand SSB) bursts (or a duration of time window for on-demand signal (e.g., on-demand SSB) transmissions) before PO is configured/indicated/determined based on a second example of the present disclosure.

In one example, at least an indication of actually transmitted index(es) in a burst (e.g., actually transmitted SSB indexes in a burst) for on-demand signal (e.g., on-demand SSB) can be known to the UE.
In one example, the indication of actually transmitted index(es) in a burst for on-demand signal (e.g., on-demand SSB) can be configured by the BS, e.g., included in system information block (e.g., SIB1 or SIBx where x>1) on the same cell, or carried by the periodic SSB on the same cell, or included in system information block (e.g., SIB1 or SIBx where x>1) in another cell. For one further implementation, this example can be applicable when there does not exist periodic SSB in the same cell.
In one example, the indication of actually transmitted index(es) index(es) in a burst for on-demand signal (e.g., on-demand SSB) can be indicated by the DL trigger. For one further implementation, this example can be applicable when there does not exist periodic SSB in the same cell.
In one example, the indication of actually transmitted index(es) in a burst for on-demand signal (e.g., on-demand SSB) can be included in the UL request. For one further implementation, this example can be applicable when there does not exist periodic SSB in the same cell.
In one example, the indication of actually transmitted index(es) in a burst for on-demand signal (e.g., on-demand SSB) can be determined based on the periodic SSB in the same cell, e.g., same indication of actually transmitted SSB in a burst as the periodic SSB in the same cell. For one further implementation, this example can be applicable when there exists periodic SSB in the same cell. For another further implementation, this example can be applicable when no explicit configuration or indication (e.g., as in the examples of the present disclosure) of the indication of actually transmitted SSB in a burst for on-demand signal (e.g., on-demand SSB) is provided to the UE.
In one example, a burst of on-demand signal can include a number of candidate occasions for the on-demand signal, wherein the number of candidate occasions equal to the number of actually transmitted index(es) in a burst, and each candidate occasion corresponds to an actually transmitted index.
In one example, a burst of on-demand signal can include a number of candidate occasions for the on-demand signal, wherein the number of candidate occasions equal to the maximum number of actually transmitted index(es) in a burst, and an actually transmitted index corresponds to an actually transmitted on-demand signal in the corresponding candidate occasion.
In one example, when there exists periodic index(es) in the same cell, the indication of actually transmitted index(es) in a burst of the on-demand signal (e.g., on-demand SSB) can be same as or a subset of the indication of actually transmitted SSB in a burst of the periodic SSB.
In one example, for the procedure of on-demand signal (e.g., on-demand SSB) used for both before PEI and before PO (e.g., as shown in 403 of FIG. 4), the indication of actually transmitted SSB in a burst for on-demand signal (e.g., on-demand SSB) before PEI and before PO can be different, e.g., a first indication of actually transmitted index(es) in a burst for on-demand signal (e.g., on-demand SSB) before PEI is configured/indicated/determined based on a first example of the present disclosure, and a second indication of actually transmitted index(es) in a burst for on-demand signal (e.g., on-demand SSB) before PO is configured/indicated/determined based on a second example of the present disclosure.

In one example, at least a time location for on-demand signal (e.g., on-demand SSB) can be known to the UE.
In one example, the time location for on-demand signal (e.g., on-demand SSB) can be based on an absolute timing, e.g., a half frame within a periodicity for on-demand signal (e.g., on-demand SSB) transmission, and/or slot(s) for on-demand signal (e.g., on-demand SSB) transmission.
In one example, the time location for on-demand signal (e.g., on-demand SSB) can be determined based on a relative timing, e.g., a reference timing and a time offset to the reference timing. For one further implementation, the reference timing can be an end or start of the paging cycle, an end or start of the paging frame, or a location of PO/PEI, or the DL trigger, or the UL request, or the periodic SSB transmission (if exists in the same cell). For another further implementation, the time offset can be known to the UE according to other examples of the present disclosure.
In one example, the time location (e.g., the absolute timing or the time offset in the relative timing) for on-demand signal (e.g., on-demand SSB) can be configured by the BS, e.g., included in system information block (e.g., SIB1 or SIBx where x>1) on the same cell, or carried by the periodic SSB on the same cell, or included in system information block (e.g., SIB1 or SIBx where x>1) in another cell. For one further implementation, this example can be applicable when there does not exist periodic SSB in the same cell.
In one example, the time location (e.g., the absolute timing or the time offset in the relative timing) for on-demand signal (e.g., on-demand SSB) can be indicated by the DL trigger. For one further implementation, this example can be applicable when there does not exist periodic SSB in the same cell.
In one example, the time location (e.g., the absolute timing or the time offset in the relative timing) for on-demand signal (e.g., on-demand SSB) can be included in the UL request. For one further implementation, this example can be applicable when there does not exist periodic SSB in the same cell.
In one example, the time location (e.g., the absolute timing or the time offset in the relative timing) for on-demand signal (e.g., on-demand SSB) can be pre-determined in the specification of system operation, e.g., a fixed time offset comparing to the reference timing.
In one example, the time location (e.g., the absolute timing or the time offset in the relative timing) for on-demand signal (e.g., on-demand SSB) can be determined based on the periodic SSB in the same cell, e.g., same time location as the periodic SSB in the same cell, or with a fixed time offset comparing to the time location of the periodic SSB. For one further implementation, this example can be applicable when there exists periodic SSB in the same cell. For another further implementation, this example can be applicable when no explicit configuration or indication (e.g., as in the examples of the present disclosure) of the time location of the on-demand signal (e.g., on-demand SSB) is provided to the UE.
In one example, for the procedure of on-demand signal (e.g., on-demand SSB) used for both before PEI and before PO (e.g., as shown in 403 of FIG. 4), the time location for on-demand signal (e.g., on-demand SSB) before PEI and before PO can be different, e.g., a first indication of time location for on-demand signal (e.g., on-demand SSB) before PEI is configured/indicated/determined based on a first example of the present disclosure, and a second indication of time location for on-demand signal (e.g., on-demand SSB) before PO is configured/indicated/determined based on a second example of the present disclosure.

In one example, at least a time interval (e.g., in a unit of OFDM symbols) between neighboring on-demand signals (e.g., on-demand SSBs) in an on-demand signal (e.g., on-demand SSB) burst can be known to the UE. For instance, the time interval can be in a unit of OFDM symbol or slot.
In one example, the time interval for on-demand signal (e.g., on-demand SSB) can be configured by the BS, e.g., included in system information block (e.g., SIB1 or SIBx where x>1) on the same cell, or carried by the periodic SSB on the same cell, or included in system information block (e.g., SIB1 or SIBx where x>1) in another cell. For one further implementation, this example can be applicable when there does not exist periodic SSB in the same cell.
In one example, the time interval for on-demand signal (e.g., on-demand SSB) can be indicated by the DL trigger. For one further implementation, this example can be applicable when there does not exist periodic SSB in the same cell.
In one example, the time interval for on-demand signal (e.g., on-demand SSB) can be included in the UL request. For one further implementation, this example can be applicable when there does not exist periodic SSB in the same cell.
In one example, the time interval for on-demand signal (e.g., on-demand SSB) can be determined based on the periodic SSB in the same cell, e.g., same time interval as the periodic SSB in the same cell. For one further implementation, this example can be applicable when there exists periodic SSB in the same cell. For another further implementation, this example can be applicable when no explicit configuration or indication (e.g., as in the examples of the present disclosure) of the time interval of the on-demand signal (e.g., on-demand SSB) is provided to the UE.
In one example, when there exists periodic SSB in the same cell, the time interval of the on-demand signal (e.g., on-demand SSB) can be smaller than or no larger than the time interval of the periodic SSB.
In one example, for the procedure of on-demand signal (e.g., on-demand SSB) used for both before PEI and before PO (e.g., as shown in 403 of FIG. 4), the time interval for on-demand signal (e.g., on-demand SSB) before PEI and before PO can be different, e.g., a first indication of time interval for on-demand signal (e.g., on-demand SSB) before PEI is configured/indicated/determined based on a first example of the present disclosure, and a second indication of time interval for on-demand signal (e.g., on-demand SSB) before PO is configured/indicated/determined based on a second example of the present disclosure.
In one example, the time interval can be pre-determined in the specification of system operation, e.g., taking a value of 0, which means on-demand signals in an on-demand signal burst are mapped to consecutive OFDM symbols (e.g., without interval in between).

In one example, at least a time and/or frequency domain structure of on-demand signal (e.g., on-demand SSB) can be known to the UE.
In one example, the time and/or frequency domain structure for on-demand signal (e.g., on-demand SSB) can be configured by the BS, e.g., included in system information block (e.g., SIB1 or SIBx where x>1) on the same cell, or carried by the periodic SSB on the same cell, or included in system information block (e.g., SIB1 or SIBx where x>1) in another cell. For one further implementation, this example can be applicable when there does not exist periodic SSB in the same cell. For another further implementation, the configuration can be from a number of candidate time and/or frequency domain structures, wherein the candidate time and/or frequency domain structures are predefined.
In one example, the time and/or frequency domain structure for on-demand signal (e.g., on-demand SSB) can be indicated by the DL trigger. For one further implementation, this example can be applicable when there does not exist periodic SSB in the same cell. For another further implementation, the indication can be from a number of candidate time and/or frequency domain structures, wherein the candidate time and/or frequency domain structures are predefined or provided by higher layer parameters.
In one example, the time and/or frequency domain structure for on-demand signal (e.g., on-demand SSB) can be included in the UL request. For one further implementation, this example can be applicable when there does not exist periodic SSB in the same cell. For another further implementation, the indication can be from a number of candidate time and/or frequency domain structures, wherein the candidate time and/or frequency domain structures are predefined or provided by higher layer parameters.
In one example, the time and/or frequency domain structure for on-demand signal (e.g., on-demand SSB) can be determined based on the periodic SSB in the same cell, e.g., same time and/or frequency domain structure as the periodic SSB in the same cell, or a subset of OFDM symbols from the periodic SSB in the same cell, or a subset of signals and/or channels from the periodic SSB in the same cell. For one further implementation, this example can be applicable when there exists periodic SSB in the same cell. For another further implementation, this example can be applicable when no explicit configuration or indication (e.g., as in the examples of the present disclosure) of the time interval of the on-demand signal (e.g., on-demand SSB) is provided to the UE.
In one example, when there exists periodic SSB in the same cell, the number of OFDM symbols of the on-demand signal (e.g., on-demand SSB) is smaller than or no larger than the number of OFDM symbols of the periodic SSB.
In one example, for the procedure of on-demand signal (e.g., on-demand SSB) used for both before PEI and before PO (e.g., as shown in 403 of FIG. 4), the time and/or frequency domain structure for on-demand signal (e.g., on-demand SSB) before PEI and before PO can be different, e.g., a first time and/or frequency domain structure for on-demand signal (e.g., on-demand SSB) before PEI is configured/indicated/determined based on a first example of the present disclosure, and a second time and/or frequency domain structure for on-demand signal (e.g., on-demand SSB) before PO is configured/indicated/determined based on a second example of the present disclosure.

In one embodiment, a DL trigger can be present in example procedures for using on-demand SSB, e.g., to indicate an activation of the on-demand signal (e.g., on-demand SSB) transmission.

In one example, the DL trigger can be a wake-up-signal (WUS), e.g., used for indicating whether to monitor PDCCH for paging or PEI, and/or for a given UE or UE group. For one instance, the WUS can be with a waveform to facilitate a low power reception (e.g., On-Off-Key (OOK) waveform), which can also be referred to as low-power wake-up-signal (LP-WUS). For another instance, the WUS can be with an orthogonal frequency division multiplexing (OFDM) waveform and/or based on at least one sequence to carry the indication.

In one example, the DL trigger can be a downlink signal (generated based on a sequence), e.g., used for indicating whether to monitor PDCCH for paging or PEI, and/or for a given UE or UE group.

In one example, the DL trigger can be PEI. For instance, a DCI format carried by a PDCCH to indicate whether to monitor PDCCH for paging, and/or for a given UE or UE group.

In one example, the DL trigger can be a random access response (RAR), e.g., in response to a PRACH to request for paging and/or on-demand SSB.

In one example, the DL trigger can be a MsgB, e.g., in response to a MsgA to request for paging and/or on-demand SSB.

In one example, the DL trigger can be system information block (e.g., PDCCH or PDSCH of the system information bock), e.g., SIB1 or SIBx where x>1.

In one example, when a UE receives the DL trigger indicating the UE to wake up, the UE can determine to monitor the associated PDCCH (e.g., PDCCH for paging or PEI).

In one embodiment, a UL request can be present in example procedure for using on-demand signal (e.g., on-demand SSB), e.g., to request for the on-demand signal (e.g., on-demand SSB) transmission.

In one example, the UL request can be an uplink wake-up-signal (UL-WUS), e.g., used for requesting on-demand signal (e.g., on-demand SSB) and/or paging. For one instance, the UL-WUS can be with a waveform to facilitate a low power reception (e.g., OOK waveform), which can also be referred to as low-power uplink wake-up-signal (LP-UL-WUS). For another instance, the UL-WUS can be with an OFDM waveform and/or based on at least one sequence to carry the indication.

In one example, the UL request can be a PRACH, e.g., used for requesting on-demand signal (e.g., on-demand SSB) and/or paging.

In one example, the UL request can be a MsgA, e.g., used for requesting on-demand signal (e.g., on-demand SSB) and/or paging.

In one example, the UL request can be an uplink signal, e.g., used for requesting on-demand signal (e.g., on-demand SSB) and/or paging.

In one example, after a UE transmits the UL request, the UE can determine to monitor a confirmation of the UL request from the BS. In another example, after a UE transmits the UL request, the UE can determine to receive the on-demand signal(s).

In one embodiment, when periodic SSB is present on a same cell where on-demand signal (e.g., on-demand SSB) is also present, there can be a relationship between the periodic SSB and the on-demand signal (e.g., on-demand SSB) as in the examples of the present disclosure.

In one example, OFDM symbols of periodic SSB(s) and OFDM symbols of on-demand signal(s) (e.g., on-demand SSB(s)) do not overlap.

In one example, half frames including periodic SSB(s) and half frames including on-demand signal(s) (e.g., on-demand SSB(s)) do not overlap.

In one example, resource elements (REs) for periodic SSB(s) and REs for on-demand signal(s) (e.g., on-demand SSB(s)) do not overlap.

In one example, bandwidth (or frequency resources) for periodic SSB(s) and bandwidth (or frequency resources) for on-demand signal(s) (e.g., on-demand SSB(s)) do not overlap.

In one example, when an intended transmission of a periodic SSB overlaps with an intended transmission of an on-demand signal (e.g., on-demand SSB), e.g., according to their configurations, the UE can assume the periodic SSB is transmitted, and the intended transmission of on-demand signal (e.g., on-demand SSB) is cancelled.

In one example, when an intended transmission of a periodic SSB overlaps with an intended transmission of an on-demand signal (e.g., on-demand SSB), e.g., according to their configurations, the UE can assume the on-demand signal (e.g., on-demand SSB) is transmitted and the intended transmission of periodic SSB is cancelled.

In one example, the periodic SSB(s) and on-demand signal(s) (e.g., on-demand SSB(s)) are on the same frequency layer, e.g., a center subcarrier of the periodic SSB(s) and a center subcarrier of the on-demand signal(s) (e.g., on-demand SSB(s)) are aligned.
In one example, the periodic SSB(s) and on-demand signal(s) (e.g., on-demand SSB(s)) are both on a synchronization raster entry.
In one example, the periodic SSB(s) and on-demand signal(s) (e.g., on-demand SSB(s)) are both on a frequency location not corresponding to any synchronization raster entry.

In one example, the periodic SSB(s) and on-demand signal(s) (e.g., on-demand SSB(s)) can be configured to be on different frequency layers.
In one example, the periodic SSB(s) can be on a synchronization raster entry, and the on-demand signal (e.g., on-demand SSB) can be not on any synchronization raster entry.
In one example, the periodic SSB(s) can be not on any synchronization raster entry, and the on-demand signal (e.g., on-demand SSB) can be on a synchronization raster entry.
In one example, the periodic SSB(s) can be on a first synchronization raster entry, and the on-demand signal (e.g., on-demand SSB) can be on a second synchronization raster entry.
In one example, the periodic SSB(s) can be on a first frequency location not corresponding to any synchronization raster entry, and the on-demand signal (e.g., on-demand SSB) can be on a second frequency location not corresponding to any synchronization raster entry.

In one example, the periodic SSB(s) and on-demand signal(s) (e.g., on-demand SSB(s)) are with a same type, e.g., either both of the them are cell-defining SSB (e.g., with associated SIB1 transmission) or both of them are non-cell-defining SSB (e.g., without associated SIB1 transmission).
In one example, this can be applicable when the periodic SSB(s) and on-demand signal(s) (e.g., on-demand SSB(s)) are on the same frequency location.

In one example, when the periodic SSB(s) are cell-defining SSB, the on-demand signal(s) (e.g., on-demand SSB(s)) can be also cell-defining SSB.
In one example, other than timing information (e.g., SFN, half frame index, SSB index), all bits in a PBCH payload for periodic SSB(s) and on-demand SSB(s) are same, or equivalently, all bits other than SFN and half frame index in a PBCH payload for periodic SSB and on-demand SSB are same, when periodic SSB and on-demand SSB have the same SSB index.
In one example, this can be applicable when the periodic SSB(s) and on-demand SSB(s) are on the same frequency location.

In yet another example, when the periodic SSB(s) are non-cell-defining SSB, the on-demand signal(s) (e.g., on-demand SSB(s)) can be also non-cell-defining SSB.
In one example, other than timing information (e.g., SFN, half frame index, SSB index), all bits in a PBCH payload for periodic SSB(s) and on-demand SSB(s) are same, or equivalently, all bits other than SFN and half frame index in a PBCH payload for periodic SSB and on-demand SSB are same, when periodic SSB and on-demand SSB have the same SSB index.
In one example, this can be applicable when the periodic SSB(s) and on-demand SSB(s) are on the same frequency location.

In yet another example, when the periodic SSB(s) are cell-defining SSB, the on-demand signal(s) (e.g., on-demand SSB(s)) can be non-cell-defining SSB.
In one example, the k_SSB value for the periodic SSB(s) and on-demand SSB(s) can be different.
In one example, this can be applicable when the periodic SSB(s) and on-demand SSB(s) are on different frequency locations.

In one example, a first sequence for primary synchronization signal (PSS) in the periodic SSB(s) and a second sequence for PSS in the on-demand signal(s) (e.g., on-demand SSB(s)) can be different.
In one example, this can be applicable when the periodic SSB(s) and on-demand signal(s) (e.g., on-demand SSB(s)) are on the same frequency location.
In one example, the first sequence and the second sequence can be generated using different generation equations (e.g., different iteration equations for the M-sequence).
In one example, the first sequence and the second sequence can be generated using different cyclic shifts.
In one example, the first sequence and the second sequence can be generated using different initial conditions.
In one example, the first sequence and the second sequence can be generated using different cover sequences.

In another example, a first sequence for secondary synchronization signal (SSS) in the periodic SSB(s) and a second sequence for SSS in the on-demand signal(s) (e.g., on-demand SSB(s)) can be different.
In one example, this can be applicable when the periodic SSB(s) and on-demand signal(s) (e.g., on-demand SSB(s)) are on the same frequency location.
In one example, the first sequence and the second sequence can be generated using different generation equations (e.g., different iteration equations for at least one of the M-sequences generating SSS).
In one example, the first sequence and the second sequence can be generated using different cyclic shifts.
In one example, the first sequence and the second sequence can be generated using different initial conditions.
In one example, the first sequence and the second sequence can be generated using different cover sequences.

In one example, a UE expects the REs for on-demand signal(s) (e.g., on-demand SSB(s)) do not overlap with REs determined or scheduled or configured for other downlink or uplink signal or channel.

In another example, if the REs for on-demand signal(s) (e.g., on-demand SSB(s)) overlaps with REs determined or scheduled or configured for other downlink or uplink signal or channel, the UE cancels the reception of other downlink signal or channel, or cancels the transmission of other uplink signal or channel.
In one example, the downlink signal or channel does not include PDCCH and/or PDSCH of paging.
In one example, the downlink signal or channel does not include periodic SSB.
In one example, the downlink signal or channel does not include PDCCH and/or PDSCH of SIB1 or SIBx where x>1.

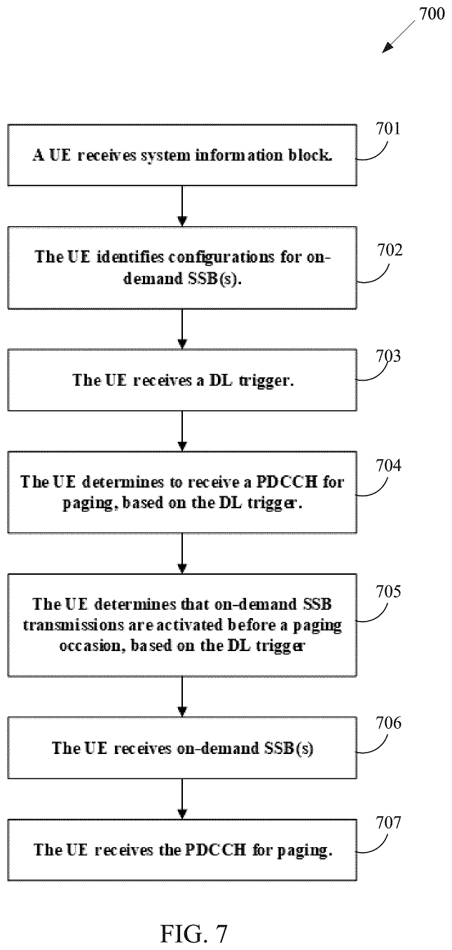

In one embodiment, an example UE procedure for on-demand signal (e.g., on-demand SSB) in paging operation is shown in FIG. 7.

FIG. 7 illustrates a method 700 performed by a UE in a wireless communication system according to embodiments of the present disclosure. The method 700 may be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method 700 begins with the UE receiving a system information block (701). \ The UE then identifies configurations for on-demand SSB(s) (702). The UE then receives a DL trigger (703). The UE then determines to receive a PDCCH for paging, based on the DL trigger (704). The UE then determines that on-demand SSB transmissions are activated before a paging occasion, based on the DL trigger (705). The UE then receives on-demand SSBs (706). The UE then receives the PDCCH for paging (707).

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of higher layer parameters; and
a processor operably coupled to the transceiver, the processor configured to:
determine, based on the set of higher layer parameters, a first set of configurations for paging and a second set of configurations for an on-demand signal;
identify a first set of time domain occasions for paging information based on the first set of configurations;
identify a second set of time domain occasions for the on-demand signal based on the second set of configurations; and
determine an association between the first set of time domain occasions and the second set of time domain occasions,
wherein the transceiver is further configured to:
receive the on-demand signal based on the second set of time domain occasions; and
receive the paging information based on the first set of time domain occasions and the association.

2. The UE of claim 1, wherein the processor is further configured to perform radio resource management (RRM) measurement based on the on-demand signal.

3. The UE of claim 1, wherein the processor is further configured to perform synchronization based on the on-demand signal.

4. The UE of claim 1, wherein the second set of configurations include at least one of:
a first frequency location;
a physical cell identity;
a subcarrier spacing;
a transmission power;
a periodicity;
a number of time domain occasions within the periodicity;
a number of transmission bursts; and
an indication of actually transmitted beam indices within one transmission burst.

5. The UE of claim 4, wherein the processor is further configured to:
determine a second frequency location for synchronization signal and physical broadcast channel (SS/PBCH) blocks, wherein the SS/PBCH block is cell-defining and the second frequency location corresponds to a synchronization raster entry; and
determine that the first frequency location is different from the second frequency location.

6. The UE of claim 5, wherein the processor is further configured to determine that frequency resources for the SS/PBCH blocks do not overlap with the on-demand signal in a frequency domain.

7. The UE of claim 1, wherein the processor is further configured to determine not to receive a channel in response to a determination that a resource element for the channel overlaps with the on-demand signal.

8. A base station (BS) in a wireless communication system, the BS comprising:
a processor configured to:
determine a first set of configurations for paging and a second set of configurations for an on-demand signal, wherein:
the first set of configurations include configurations for a first set of time domain occasions for paging information; and
the second set of configurations include configurations for a second set of time domain occasions for the on-demand signal; and
determine an association between the first set of time domain occasions and the second set of time domain occasions; and
a transceiver operably coupled to the processor, the transceiver configured to:
transmit a set of higher layer parameters including the first and second set of configurations;
transmit the on-demand signal based on the second set of time domain occasions; and
transmit the paging information based on the first set of time domain occasions and the association.

9. The BS of claim 8, wherein the processor is further configured to determine configurations for radio resource management (RRM) measurement based on the on-demand signal.

10. The BS of claim 8, wherein the second set of configurations include at least one of:
a first frequency location;
a physical cell identity;
a subcarrier spacing;
a transmission power;
a periodicity;
a number of time domain occasions within the periodicity;
a number of transmission bursts; and
an indication of actually transmitted beam indices within one transmission burst.

11. The BS of claim 10, wherein the processor is further configured to:
determine a second frequency location for synchronization signal and physical broadcast channel (SS/PBCH) blocks, wherein the SS/PBCH block is cell-defining and the second frequency location corresponds to a synchronization raster entry; and
determine that the first frequency location is different from the second frequency location.

12. The BS of claim 11, wherein the processor is further configured to determine that frequency resources for the SS/PBCH blocks do not overlap with the on-demand signal in a frequency domain.

13. The BS of claim 8, wherein the processor is further configured to determine not to transmit a channel, in response to determination that a resource element for the channel overlaps with the on-demand signal.

14. A method of a user equipment (UE) in a wireless communication system, the method comprising:
receiving a set of higher layer parameters;
determining, based on the set of higher layer parameters, a first set of configurations for paging and a second set of configurations for an on-demand signal;
identifying a first set of time domain occasions for paging information based on the first set of configurations;
identifying a second set of time domain occasions for the on-demand signal based on the second set of configurations;
determining an association between the first set of time domain occasions and the second set of time domain occasions;
receiving the on-demand signal based on the second set of time domain occasions; and
receiving the paging information based on the first set of time domain occasions and the association.

15. The method of claim 14, further comprising performing radio resource management (RRM) measurement based on the on-demand signal.

16. The method of claim 14, further comprising performing synchronization based on the on-demand signal.

17. The method of claim 14, wherein the second set of configurations include at least one of:
a first frequency location;
a physical cell identity;
a subcarrier spacing;
a transmission power;
a periodicity;
a number of time domain occasions within the periodicity;
a number of transmission bursts; and
an indication of actually transmitted beam indices within one transmission burst.

18. The method of claim 17, further comprising:
determining a second frequency location for synchronization signal and physical broadcast channel (SS/PBCH) blocks, wherein the SS/PBCH block is cell-defining and the second frequency location corresponds to a synchronization raster entry; and
determining that the first frequency location is different from the second frequency location.

19. The method of claim 18, further comprising determining that frequency resources for the SS/PBCH blocks do not overlap with the on-demand signal in a frequency domain.

20. The method of claim 14, further comprising determining not to receive a channel, in response to determination that a resource element for the channel overlaps with the on-demand signal.
